(19) United States
(12) Patent Application Publication
(10) Pub. No.: US 2012/0180073 A1
(43) Pub. Date: Jul. 12, 2012

(54) Mobile Device Application Framework

(76) Inventor: Hin Leung HUNG, Vancouver (CA)

(21) Appl. No.: 13/341,698

(22) Filed: Dec. 30, 2011

Related U.S. Application Data
(60) Provisional application No. 61/430,385, filed on Jan. 6, 2011.

(51) Int. Cl. G06F 17/00; G06F 9/54

(52) U.S. Cl. 719/313; 715/234

(57) ABSTRACT

A mobile-application framework facilitates construction of interactive data display and manipulation applications without imperative programming by providing URI matching and substitution functions, wherein a substituted URI can refer to a resource contained as a hierarchically-organized item within a monolithic data stream or file.

### CONTINUITY AND CLAIM OF PRIORITY

This is an original U.S. utility patent application which claims the benefit of provisional patent application No. 61/430,385 filed 6 Jan. 2011.

### FIELD

The invention relates to application support infrastructures for mobile devices. More specifically, the invention relates to systems, data structures and allocations of functionality among communications, data processing, display and user-interface devices that interoperate to deliver dynamic and interactive content to mobile device users.

### BACKGROUND

The conception of the World Wide Web by Tim Berners-Lee in 1989 unleashed a torrent of new technologies that build on the basic ideas of Internet data communication, content delivery and presentation, and end-user interaction. Many of these technologies are widely deployed and relied upon for applications from commerce and entertainment to research and political activism. A significant proportion of the data flowing over the Internet at any time is coming from, or destined for display on, the web browser of a computer.

Somewhat more recently, development of improved low-power data processing, wireless communications, small-format displays and high energy density batteries has led to an explosion in the number and capabilities of mobile or hand-held devices such as cellular telephones, personal digital assistants (“PDAs”), digital cameras, global positioning system (“GPS”) units, digital music players, and hybrid devices that combine several of these different functions. A frequent design goal of such devices is that they permit their users to access legacy Web-based resources and applications.

Unfortunately, due to differences between the computational and human-interface capabilities of mobile devices and traditional personal computers (PCs), the obvious approach of porting PC software to run on the mobile device often yields disappointing results. Furthermore, differences between the resources available on different types of mobile device make development of mobile-device-specific applications a tedious undertaking—an application that provides convenient, effective access to a web application for a cell-phone user may not work well on a PDA, or even on a different type of cell phone. The low-level functions and capabilities required to give a user access to a web application are well understood: data communication protocols, display rendering, user selections (e.g. mouse clicks or screen taps), keyboard entry and so on; but the best way to combine these primitives into a fast, maintainable, flexible and extensible system is still the subject of active research and development.

In the field of mobile application development and deployment, an innovative framework that distributes responsibility for accomplishing parts of an end-to-end application task among the participating devices and systems can provide significant gains in programming and operational efficiency.

### SUMMARY

A mobile application development and deployment framework is based on documents prepared in a structured markup language such as Extensible Markup Language (“XML”) (as described, for example, in specifications issued by the World Wide Web Consortium, W3C). Such markup languages will be referred to in this disclosure as “ABML” to highlight that they are Markup Languages, without unnecessarily limiting embodiments to a particular markup language such as XML. An ABML application (or “app”) is an interactive data retrieval, display and interaction system based on an ABML document that ties together key functional elements such as user-interface components, and describes what data to show, from where to retrieve it, how to present it, and what to allow the user to do with it. ABML supports and encourages a clear separation between user interface and application content, and provides features and functionality that allow developers to build robust, portable mobile applications quickly.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an environment where an embodiment of the invention can be deployed.

FIG. 2 shows a prior-art interaction between a web browser and a web server to deliver and display a document.

FIG. 3 shows some features of Uniform Resource Locator (“URL”).

FIG. 4 shows features of a “relative” Uniform Resource Indicator (“URI”).

FIG. 5 shows an interaction between a browser implementing an embodiment of the invention and a prior-art web server, which delivers an ABML application to the browser.

FIG. 6 is a flow chart outlining a portion of the methods performed by an ABML browser.

FIG. 7 is a flow chart outlining one URI-processing method that may be used by an embodiment of the invention.

FIG. 8 is a flow chart outlining one method an embodiment of the invention may use after performing URI dispatch table processing.

FIG. 9 is a flow chart outlining another method an embodiment of the invention may use after performing URI dispatch table processing.

FIGS. 10a and 10b are a flow chart outlining another method an embodiment of the invention may use to associate objects with data fragments from external content sources for display and other computational purposes.

### DETAILED DESCRIPTION

Embodiments of the invention combine prior-art and novel features in a new and unique arrangement to solve a known problem in a more efficient and effective way. Since both the problem and some inferior solutions are known, it is important to distinguish the embodiments as claimed, as a whole, from what has gone before, since a portion of the invention's utility lies in its improved secondary characteristics compared to the prior art, and not merely in its ability to support alternative implementations of existing web applications.

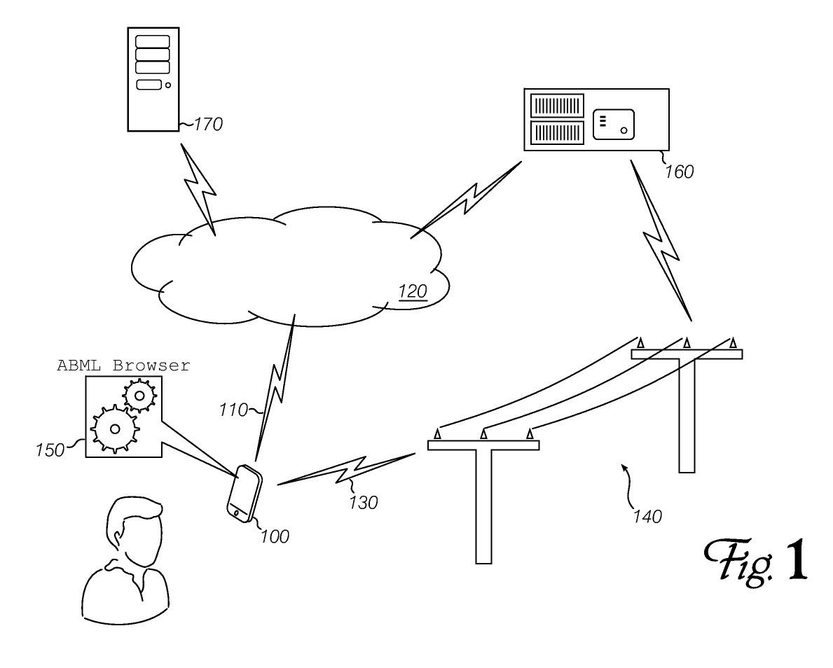

FIG. 1 shows some devices and facilities in an environment where an embodiment of the invention operates to coordinate the delivery of information (“content”) and/or capability to a user of a mobile device 100. Device 100 may be a cell phone (as shown here), a PDA, or a more-specialized mobile device such as a GPS receiver, still- or digital-video camera, or a hybrid device. It may also be a subsystem or component of a different machine, such as an entertainment or navigation center of a vehicle.

Device 100 must have one or more communication channels through which it can exchange data with other participants in the system. The communication channels are often wireless (i.e. , radio- or light-based) but wired connections can be used also. In FIG. 1, device 100 can communicate over a Wi-Fi link 110 using Internet Protocol (“IP”) data packets (and subsequently over a distributed IP data network such as the Internet 120), or over a GSM (“global system for mobile communications,” a.k.a. cellular network) connection 130. GSM data may subsequently travel over a public switched telephone network (“PSTN”) 140. Some communication participants 160 may be reachable by more than one channel, so channel selection may be governed by bandwidth, latency, or cost to use. Other participants 170 may be accessible only via one type of communication channel. Some embodiments of the invention abstract away the low-level mechanics of delivering data from device to device, so they can function over any communication medium or combination of media.

Software 150 running at device 100, acting under the control of an ABML document and as modified by inputs from the user of device 100 and information retrieved from remote communication partners, coordinates the acquisition of information and its display to the user. Software 150 may be referred to as an “ABML browser,” and it performs some display and user-interface functions similarly to a traditional web browser presenting a Hypertext Markup Language (“HTML”) document, as well as functions unique to embodiments of the invention. Some inventive ABML browsers may be constructed so that the user interface displays they produce resemble the displays of other native applications running on the device, rather than the more generic sorts of displays that traditional web browsers tend to create.

An important feature of an ABML document is the Uniform Resource Identifier (“URI”) dispatch table, which defines how the application is to process URIs and process or move data (resources) around to accomplish the purposes of the application. Before describing the URI dispatch table and its operation, however, it may be useful to review some relevant portions of current web-browser operation.

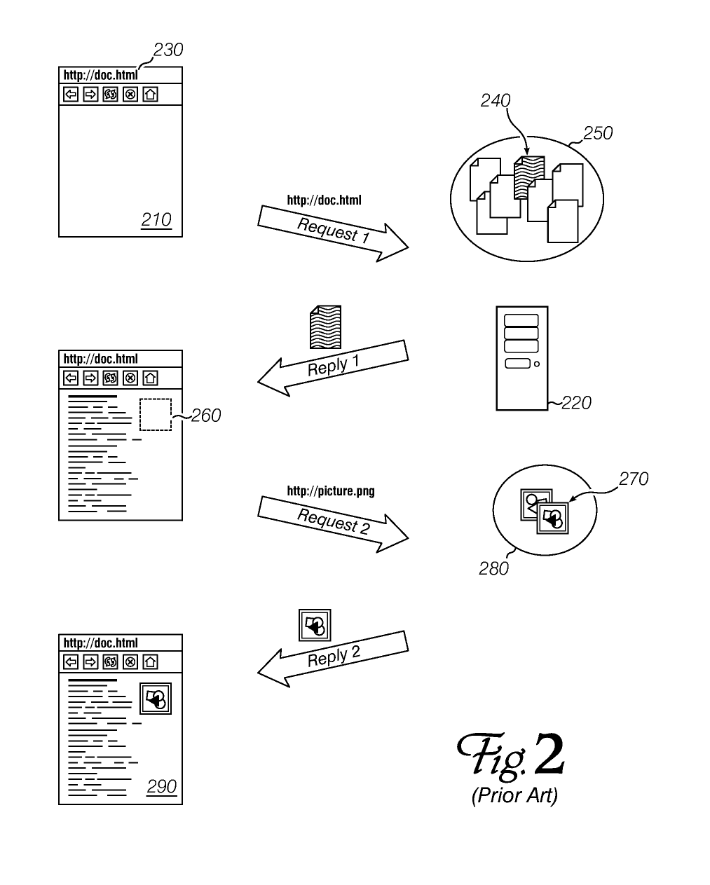

FIG. 2 shows a prior-art web browser 210 interacting with a prior-art server 220 to retrieve and display a simple web page. First, the user enters the Uniform Resource Locator (“URL”) 230 of the web page (or perhaps clicks on a link presented by a search engine). The URL is a URI (it identifies the web page) but it also includes information instructing the browser how to access the resource. Typically, this information appears at the beginning of the URL as the “scheme,” and in many cases is the text string “http://”, which indicates that the Hypertext Transport Protocol (“HTTP”) is to be used to retrieve the resource.

Clicking or entering the URL causes browser 210 to issue a request to server 220 for a first portion 240 of the web page. In this example, the URI selects document 240 from among a set of resources 250 that are available from server 220. This first portion is usually an HTML document containing text and formatting information. Browser 210 receives the first portion and prepares it for display. During the preparation, browser 210 encounters a reference 260 to a second portion of the web page (in this example, reference 260 identifies an image that is intended to be displayed on the web page). Browser 210 issues a second request to server 220 for the image corresponding to reference 260, and receives image 270 from among a set of images 280 that server 220 can provide. Finally, the browser displays the formatted web page, including image 270, as shown at 290.

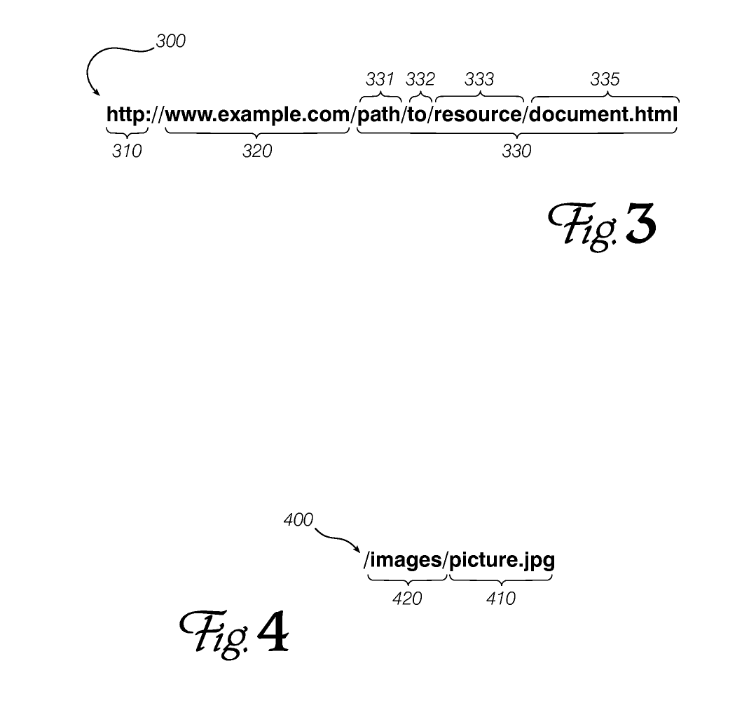

In addition to the foregoing review of traditional web browser—web server interaction, it may also be useful to review the structure of URIs and URLs by which online resources are often named. As shown in FIG. 3, a URL (generally 300) is made up of a number of parts. A first part 310 usually identifies an access method for obtaining the resource. Here, the access method “http” indicates that the Hypertext Transfer Protocol can be used. Resources may be available through multiple access methods. A second part of the URL 320, which is separated from the first part 310 by the literal string of characters “://” (colon, slash, slash), identifies a computer or server from which the resource may be obtained. This part of a URL may be stated as a numeric Internet Protocol (“IP”) address, and may include additional information necessary to locate, contact or interact with the computer. Finally, a third part of the URL 330 provides information that is typically used by the computer identified by part 320 to locate or produce the desired resource. This part may be subdivided into segments 331, 332, 333, 335 by a delimiter character such as the forward slash (‘/’). URL 300 would conventionally refer to a Hypertext Markup Language (“HTML”) document named “document.html”, which is stored in a hierarchical directory structure in nested directories named “path”, “to” and “resource”. URIs are specified in greater detail in publications such as Request For Comments (“RFC”) number 3986, published January 2005 by The Internet Society's Internet Engineering Task Force (“IETF”), the contents of which are incorporated by reference. It is appreciated that different portions of a URI may be interpreted or even modified by various systems involved in delivering a resource or capability denoted by the URI to an end user.

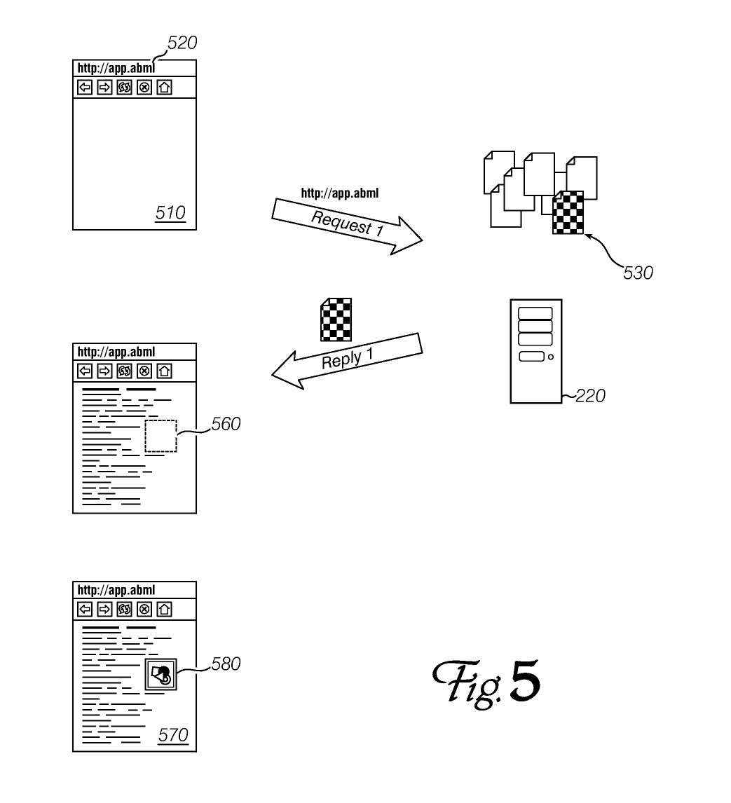

FIG. 4 illustrates a different form of URI 400, which lacks the method 310 and host 320 portions of URI 300. Systems typically interpret such “relative” URIs as referring to a resource available from the same host, and by the same method, as the base resource. Thus, for example, if the “document.html” resource identified by the URI of FIG. 3 contained URI 400, it might refer to an image (“picture.jpg” 410) found at the same server (“www.example.com”) but in a different directory (“/images” 420) from “document.html”. A URI that omits the leading slash character might be interpreted to refer to a resource that is found in the same directory as its base resource.

Now, in a final expository digression before examining an embodiment of the invention, it may be useful to define and adopt a specific expression for what might informally be considered a “document” or “resource” of the invention. The term “document” has a specific and limited meaning in the context of XML, and it is important to avoid the misunderstanding that an ABML “document” is nothing more than an XML document. Therefore, in the remainder of this description, the expression “ABML package” will be used to indicate a data stream, file or similar object, including an ABML document, which also contains other information that can be processed as described here. As will be noted again later, a useful characteristic of many markup languages is their ability to store or represent hierarchical data in a linear text stream or file format. However, other packaging methods also permit the representation of hierarchical data in a linear form. ABML packages can also be constructed as an archive or compressed archive (for example, a “tar” or “cpio” archive or a “zip” file) containing the ABML document and associated resources.

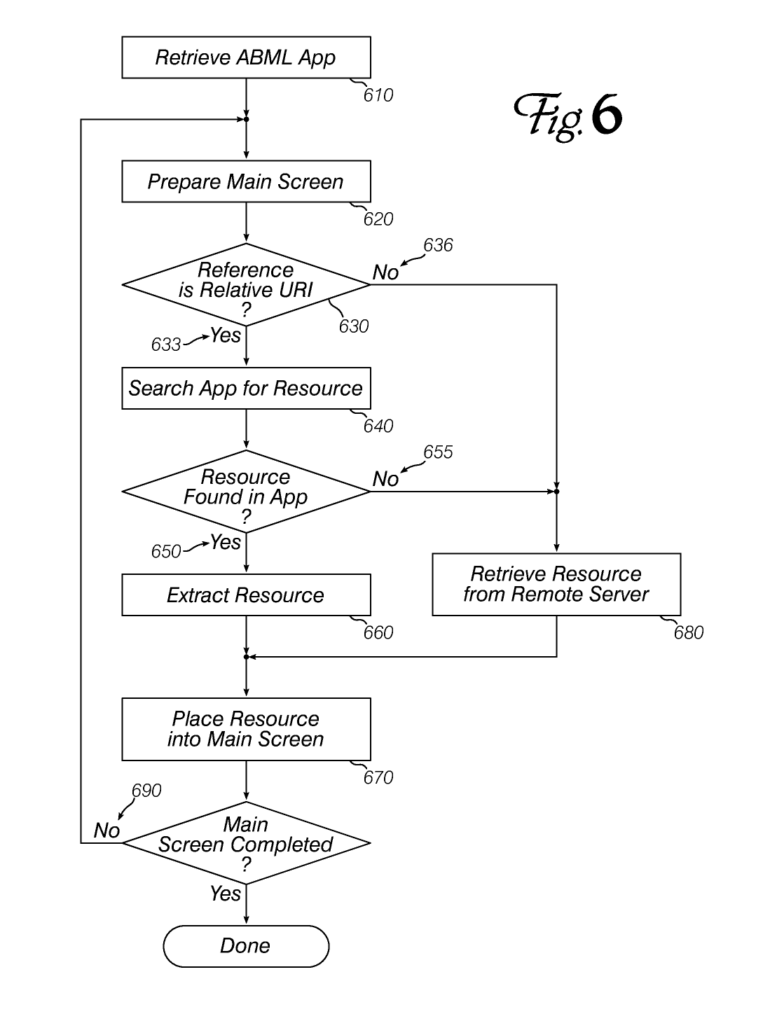

An embodiment of the invention may be a computer program, that is, a sequence of executable instructions to cause a programmable processor to perform the actions described here. Turning now to FIG. 5, the inventive computer program, whose representative user-interface window is shown at 510, begins an example series of operations similarly to a standard browser: a URL 520 is entered (or a link is clicked) to cause the program to retrieve a resource from a server 220. (This embodiment can interact with a prior-art server; no special operational support is required.) URL 520 identifies a resource 530, which is an ABML package that may comprise additional resources or information. Server 220 returns the requested package to program 510 and further processing begins.

An ABML document in an ABML package 530 can include references which direct program 510 to retrieve additional resources from server 220 (or from other remote servers), just as a prior-art HTML document can. However, an ABML package includes information and data structures that cannot be processed by a prior-art web browser. This information and the functions of ABML browser 510 that may be invoked thereby are described below.

A first function of program 510 that may be invoked by an ABML application is to obtain a related resource from within the package itself, rather than via a second request to an external server. For example, if package 530 is to include an image in its display at the position indicated by 560, the image could be stored within the package and referred to by a self-referential URI. Thus, ABML browser 510 is able to display the user-interface window shown at 570 by locating image 580 within package 530′s self-contained data resources and presenting it, without issuing a second request to server 220 to obtain the image.

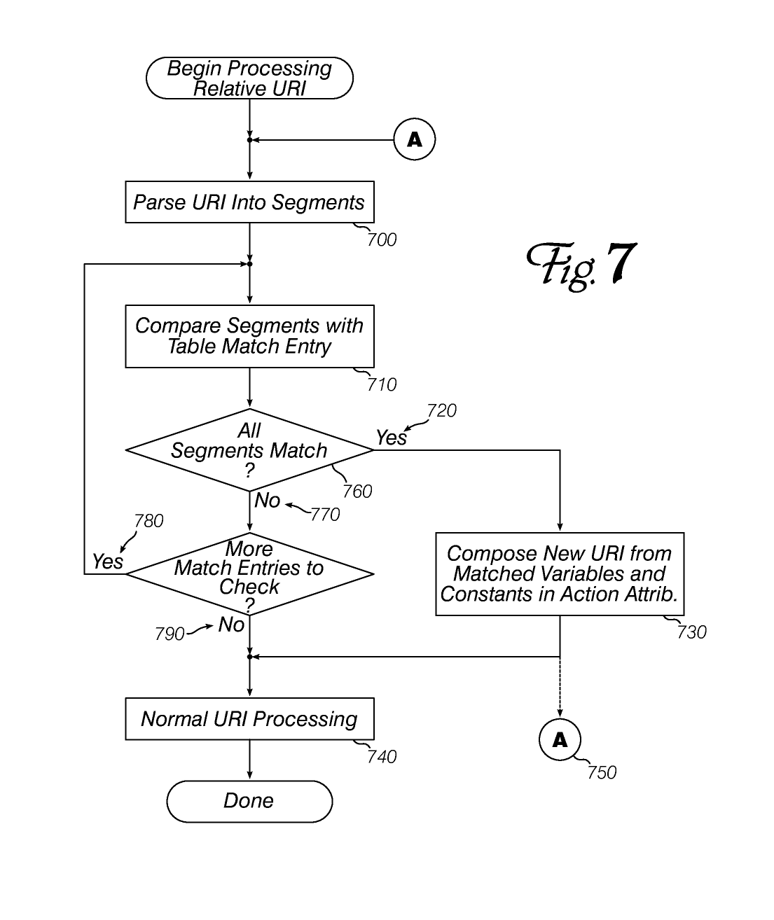

The flow chart of FIG. 6 outlines this process in greater detail: first, an ABML browser retrieves an ABML package based on a URL entered or clicked by the user (610). The main screen of the app is prepared (620) by, for example, formatting text paragraphs, laying out tables, placing user-interface controls and so on. During this processing, the browser may encounter references to additional resources to be included in the main screen display. For each such reference, the browser determines whether the reference is a relative URI (as described above in the discussion of FIG. 4) (630). If it is a relative URI (633), then the ABML package is searched to find the named resource (640). If the resource is contained in the package (650), then it is extracted (660) and placed into the display (670). If the resource is not contained in the package (655), or if the URI is not relative (636), then the browser may issue a request to a remote server to retrieve the resource (680). This retrieved resource may then be processed the same as if it had been found locally (670). If the main screen display has not yet been competed (690), these operations are repeated.

Resources (e.g., images) and other related materials within an ABML package may be stored hierarchically (a storage arrangement that is facilitated by the package structure) and referred to by relative URIs that are based on the URI of the ABML package. Including related resources within the package can improve performance because an ABML browser need not make additional requests to an external server for these resources, and it alleviates versioning problems that can afflict complex applications when the version of a remote resource does not match that required by the application. The package can be created with all of its critical components at the same time, so the correct versions are always available. Furthermore, by leveraging another feature of an ABML package(described below), program 510 can select from among several different resources (e.g., images) contained within the package, based on the state of other portions of the app, and/or upon actions performed by the user.

A second function of program 510 that may be invoked by an ABML document is to instantiate a user-interface object (“UI object,” also sometimes a “UI component,” e.g., a button, checkbox or a text-entry field). The object will be created and managed by program 510 (perhaps relying on a library of software functions provided by the underlying computer platform) but relevant portions of the object's state and operation will be available to the app via a name that is similar in syntax to other resource identifiers that are used by embodiments of the invention. For example, a button bearing the legend “OK” that is displayed on the user-interface screen may be referred to by the name “/main_window/button/OK”. UI objects may maintain additional information or attributes that can be examined or set by name. For example, the contents of a text-entry field may be manipulated by an ABML app by referring to the name “/main_window/text_field#contents”. Furthermore, names are associated with events or actions of the UI object. The “OK” button mentioned above, when clicked, may cause an ABML browser implementing an embodiment of the invention to begin processing the URI-like name “/main_window/button/OK#clicked”. These names are called “UI-object paths”. As the last two examples show, UI-object paths may include path segments separated by different delimiters (here, the slash character, ‘/’, and the hash or pound character, ‘#’). Differing delimiters can be used in the URI dispatch table, described below, to distinguish different parts of the URI and to process them differently. Standards for URI construction permit the use of a number of non-alphanumeric characters; an embodiment may use such characters to provide more-precise control over identification and activation of internal and external resources. (Alphanumerics could also be used as delimiters to mark URI sections, but such use might be counterintuitive or unexpected among developers, so it is not likely to be as useful for these purposes.) Delimiter and delimiter-like characters may be used to indicate resource types as well.

Since the relative URIs referring to resources found within the ABML package and the URI-like UI-object paths are syntactically similar, they will be lumped together under the rubric “self-referential URIs” in the following discussion. It is appreciated that UI-object paths are not actual URIs, but treating them as if they are provides useful capabilities to ABML app developers. Both types of identifiers are “self referential” in the sense that they refer to data, objects or events that are part of the ABML app.

A third feature of an embodiment of the invention is the URI dispatch table of an ABML package (and the corresponding logic of an ABML browser to interpret the table). The URI dispatch table serves as a sort of switchboard to direct the ABML browser in retrieving and displaying information and responding to user input. At a very high level, the dispatch table can be thought of as a way of decoding information in a URI into a set of variables; the variables can then be used to construct a new URI (perhaps one containing information from more than one input URI, or one that expresses the information in the input URI(s) differently).

Listing 1 below shows a simple ABML package expressed in XML. Lines 70-200 show a small URI dispatch table. A practical application would be likely to have many more entries. These sample entries are given names intended to suggest their functions for ease of explanation, but those of skill in the art will understand that the names are generally arbitrary, and may be selected in any manner that appeals to a software developer.

| | |
|---|---|
| 10 | <?xml version=‘1.0’?> |
| 20 | <abml:abml xmlns:abml=‘http://www.appbeetle.com/2009/abml’ |
| 30 | xmlns:ar=‘http://www.appbeetle.com/2009/abml/article’ |
| 40 | xmlns:pc=‘http://store.example.com/2010/product-catalog’ |
| 50 | name=‘Store Example’> |
| 60 | |
| 70 | <abml:dispatch> |
| 80 | <abml:entry pattern=‘products/{$filter}’ |
| 90 | show=‘tabs/products’/> |
| 100 | <abml:entry pattern=‘{$tab_name}’ |
| 110 | show=‘tabs/{$tab_name}’/> |
| 120 | <abml:entry pattern=‘product/{$product_id}’ |
| 130 | show=‘view_product’/> |
| 140 | <abml:entry pattern=‘supplier/{$supplier_id}’ |
| 150 | show=‘view_supplier’/> |
| 160 | <!-- typically more entries here --> |
| 170 | <abml:entry show=‘show_unable_to_display’/> |
| 180 | <abml:ui-object-not-found |
| 190 | show=‘show_unable_to_display’/> |
| 200 | </abml:dispatch> |
| 210 | |
| 220 | <abml:tab-container-window name=‘tabs’> |
| 230 | |
| 240 | <!-- “products_tab_icon.png” is a local resource --> |
| 250 | <abml:tabbed-window name=‘products’ |
| 260 | img=‘products_tab_icon.png’> |
| 270 | <abml:control-bar name=‘controls’> |
| 280 | <abml:selection-control name=‘filter’ select-item= |
| | ‘{$filter}’ id=‘products_filter’> |
| 290 | <abml:selection-item title=‘Discounted’data=‘discounted’/> |
| 300 | <abml:selection-item title=‘All’data=‘all’/> |
| 310 | </abml:selection-control> |
| 320 | <abml:button name=‘help_button’/> |
| 330 | </abml:control-bar> |
| 340 | |
| 350 | <!-- the value of data-src attribute identifier a |
| 360 | remote resource --> |
| 370 | <abml:list-view grouped=‘true’ |
| 380 | data-src=‘http://store.example.com/products/{$filter}’> |
| 390 | <abml:list-section-template select=‘/pc:catalog/pc:category’ |
| 400 | header-title=‘{@name}’> |
| 410 | <abml:custom-list-item-template select=‘pc:product’> |
| 420 | <abml:article-view select=‘ar:article’/> |
| 430 | <abml:case event=‘item-selected’> |
| 440 | <abml:go href=‘product/{@product_id}’/> |
| 450 | </abml:case> |
| 460 | </abml:custom-list-item> |
| 470 | </abml:list-section> |
| 480 | </abml:list-view> |
| 490 | |
| 500 | <!-- |
| 510 | may be replaced with |
| 520 | <abml:case event=‘selection-changed’ |
| 530 | source=‘controls/filter’> |
| 540 | --> |
| 550 | <abml:case event=‘controls/filter#selection-changed’> |
| 560 | |
| 570 | <!-- |
| 580 | may be replaced with |
| 590 | <abml:go href=‘products/{get-property-by-id( |
| 600 | “products_filter”, “selected-item-data”)}/>’ |
| 610 | --> |
| 620 | <abml:go href=‘products/{get-property( |
| 630 | “controls/filter#selected-item-data”)}’/> |
| 640 | </abml:case> |
| 650 | <abml:case event=‘controls/help_button#clicked’> |
| 660 | . |
| 670 | . |
| 680 | </abml:case> |
| 690 | </abml:tabbed-window> |
| 700 | |
| 710 | <abml:tabbed-window name=‘search’ img=‘search_tab_icon.png’> |
| 720 | . |
| 730 | . |
| 740 | </abml:tabbed-window> |
| 750 | . |
| 760 | . |
| 770 | </abml:tab-container-window> |
| 780 | |
| 790 | <abml:window name=‘view product’> |
| 800 | <abml:nav-bar> |
| 810 | <abml:back-button href-if-no-prev=‘tabs/products/0’/> |
| 820 | </abml:nav-bar> |
| 830 | . |
| 840 | . |
| 850 | <!-- the value in data-src attribute identifier a |
| 860 | remote resource --> |
| 870 | <abml:article-view |
| | data-src=‘http://store.example.com/product/{$product_id}’ |
| 880 | select=‘ar:article’> |
| 890 | </abml:article-view> |
| 900 | </abml:window> |
| 910 | |
| 920 | <abml:window name=‘view_supplier’> |
| 930 | . |
| 940 | . |
| 950 | </abml:window> |
| 960 | |
| 970 | <abml:window name=‘show_unable_to_display’> |
| 980 | . |
| 990 | . |
| 1000 | </abml:window> |
| 1010 | </abml:abml> |

### Listing 1

Most entries in the dispatch table have two attributes: an attribute for matching (called “pattern”) and an attribute for acting (called “show”). Each attribute is similar to a partial or relative URI in that it comprises a number of segments separated by delimiters, but some segments are expressed in a special form consisting of an opening curly brace (‘{’) followed by a dollar sign (‘$’), an identifier and a closing curly brace (‘}’). (The particular syntax shown and described here is borrowed from the XML Stylesheet Language for Transformations [“XSLT”] and is favored because it is concise and unambiguous, and because users' intuitions about its meaning are likely to be near to the mark. However, all that is necessary for an embodiment is that it be possible to identify unambiguously and process portions of URIs and dispatch table entries according to the following method.) The segments in the “{$name}” form are considered variable declarations, and portions of a URI that match them in a pattern attribute are assigned as the variable's value. Then, when processing an action attribute, variables' values are substituted.

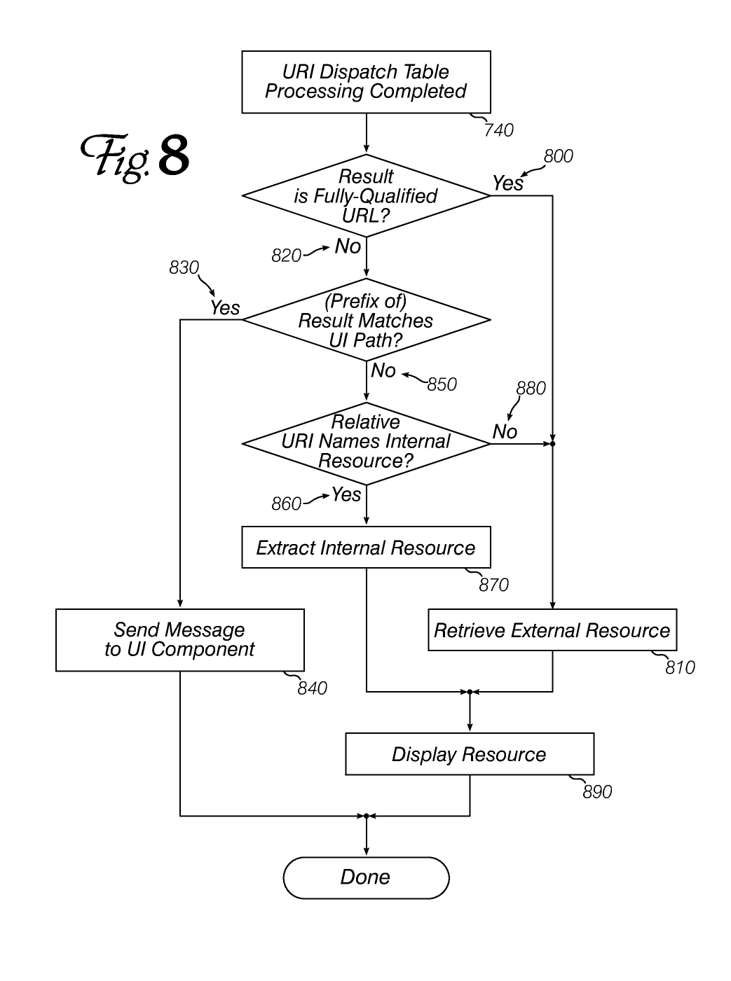

FIG. 7 is a flow chart outlining operations of an ABML browser processing URIs (and URI-like strings such as UI-object paths) through a dispatch table of an ABML document. This method commences after the ABML package (with its self-contained resources) has been retrieved from a server, processed and displayed, and (in this example) in response to the user's selection or “clicking” of a link. The link corresponds to a URI, which is processed as follows: first, the input URI is parsed into segments at its delimiters (for example, at each forward slash character) (700). Next, for each URI dispatch table entry, the parsed segments are compared with the match attribute of the table entry (710), and if all constant segments match (720), a new URI is constructed from the matched variable portions of the input URI and variable and/or constant data, as specified in the action or “show” attribute (730). This newly-constructed URI may be forwarded on to normal URI processing (740) (for example, an internal or external resource may be retrieved and displayed). Alternatively, the new URI may be sent back through the URI dispatch table again (750), where it may be converted into yet another URI. The determination whether to use the converted URI immediately, or whether to repeat the conversion process, may be made based on another attribute of the matching dispatch table entry.

Returning to decision box 760, if all the segments do not match (770), then the ABML browser determines whether there are more dispatch table pattern entries to check. If there are (780), then the comparison process is repeated for those entries. If all the dispatch table entries have been checked (790), then the fully-processed (but unmodified) URI is used as-is (740).

A URI dispatch table may contain a “wild card” or “match all” entry to match URIs that do not match any other entry. The wild card entry can be used, for example, to cause the ABML browser to display a “resource not found” or “invalid operation” message. In Listing 1, for example, the dispatch table entry at line 170 lacks the “pattern” attribute so it is treated as a “match all” entry. It turns non-matching URIs into “show_unable_to_display”, which presents an error message. Similarly, the entry at 180 arranges for an appropriate error message to be displayed if the application somehow attempts to manipulate an unknown UI object.

URI pattern matching as described above is a relatively simple matter of matching non-variable sections and assigning the remaining sections (between matched, non-variable sections) as variable values. However, an embodiment can offer greater control and flexibility to an ABML app developer by, for example, providing sophisticated text-matching features such as regular expressions. (“Regular expressions” are a well-known feature of several contemporary computer-programming languages such as Perl, Ruby and Awk. Those of ordinary skill in the art are familiar with them, and technical references and tutorials are readily available.) An ABML browser that supports regular expressions in its URI dispatch table match patterns may allow the ABML app to work with a wider variety of data sources, including legacy data sources and online resources that were not designed with ABML-app processing in mind.

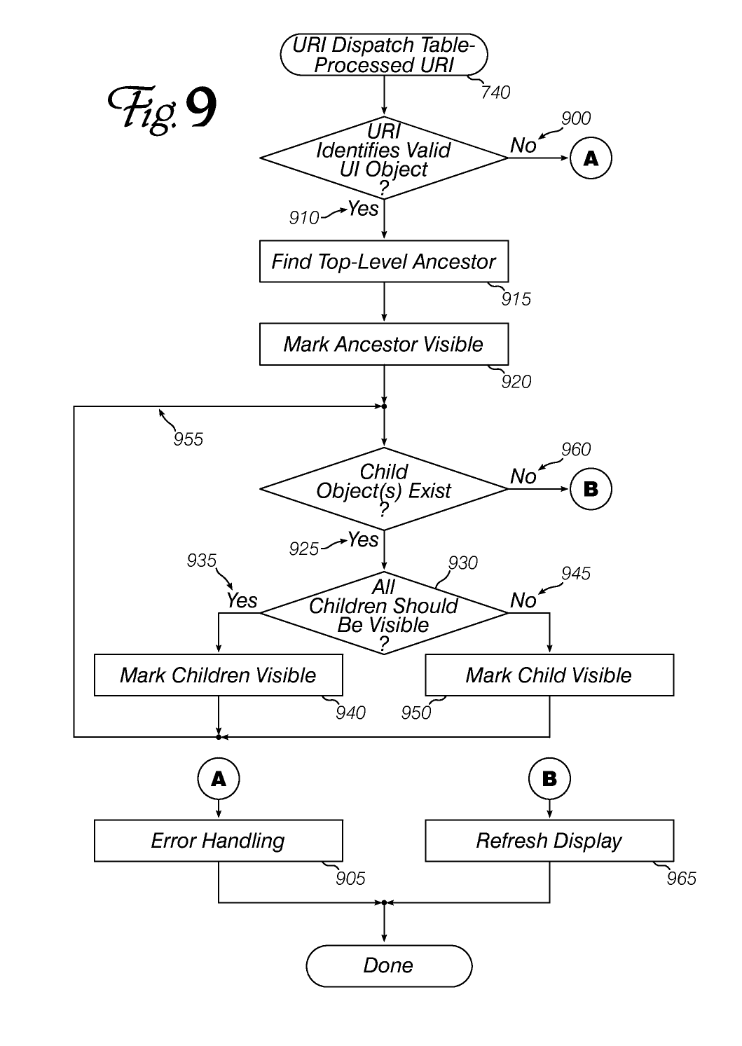

“Normal URI processing,” as used at 740, can mean a number of things in an ABML app. First, the processed, possibly converted URI may simply be an ordinary URL that refers to a document or other resource at a remote server. In this case, the ABML browser may retrieve and display the document. Second, it may be a self-referential URI, which may cause the ABML browser to find and display information contained within the ABML package. And third, it may be a UI object path, causing the ABML browser to change the state or appearance of a user-interface component. FIG. 8 shows a method of selecting among possible interpretations of a processed URI. This method gives preference to treating the URI as a UI object path.

The method begins with the URI result of the dispatch table processing outlined with reference to FIG. 7 (740). This URI is examined to see whether it is a fully-qualified URL, and if it is (800), the corresponding remote resource is retrieved (810). If the URI is not a fully-qualified URL (820), then UI component paths are examined to see whether the URI matches one of them. In some embodiments, only the URI prefix is compared (in other words, if the first part of the URI matches the UI component path, then a match is declared; any suffix of the URI is used for other purposes). If the URI (prefix) matches a UI component path (830), then an appropriate message is sent to the UI component (840). For example, the message could be the suffix (unmatched part) of the URI. The UI component responds to the message in an implementation-dependent way.

If the (relative) URI does not match any UI component path (850), then the ABML package is searched to see whether it contains a resource matching the URI. If it does (860), then that resource is extracted (870). Otherwise (880), the URI is treated as a reference to an external resource at the same server from which the ABML package was obtained, and the external resource is retrieved (810). Finally, whether located internally or retrieved externally, the resource is displayed (or otherwise used by the ABML browser executing the ABML app) (890).

The foregoing description (i.e. [0029] through [0045]) outlined general and representative features that may be found in an embodiment of the invention. Next, we describe design choices made in a specific implementation.

In this embodiment, the main components of the ABML app are UI objects (as above), event handlers (new to this embodiment, “<abml:case . . . >” as shown at, e.g., 430 to 450 in Listing 1), and a URI dispatch table (also as above, but with particular limitations). The app contains several different “screens” or sets of related data and UI objects that may be displayed during the execution of the application. When a screen is activated, it becomes visible and (typically) occupies the entire display area of the mobile device. Each screen comprises a parent window, which serves as the root of a hierarchy or tree that counts as its leaves all of the UI objects shown on that screen. When a screen and its window are activated, its children become visible; and when a different screen is activated, any currently-visible window is made invisible, while the new screen's window and children are shown.

Some UI objects can be programmed to display non-functional content (e.g., images and text), and many UI objects can be programmed to handle or respond to events that occur inside the object or one of its children. (Event handling is clone through the “<abml:case . . . >” mechanism.)

As with other executable programs, an ABML application transitions from one state to another as it operates. The state of an ABML application can be adequately defined by the states of its UI objects (e.g., which one of its screens is currently displayed, whether a UI object is programmed to display external content, what is the URL of that content, etc.) ABML encodes the state of an ABML app in a URI, and usually transitions from one state to another in response to an event such as a screen tap, button press, timer expiration, etc. The event may cause a new input URI to be processed by the ABML browser, passed through the URI dispatch table translation, and the result used as the description or specification of the post-event state.

This is somewhat similar to a typical prior-art sequence web-browser/web-server interaction: retrieve first resource, display first resource, user clicks link identifying second resource, retrieve second resource, display second resource. However, in an ABML app, most of the functionality of the remote web server can be provided by the ABML browser operating on the client device. An ABML package is largely self-contained; it has all its application screens and logic packaged together, so an ABML app only needs to download external content files during execution (if the app is designed to display external content). When an event occurs, the app can switch from one screen to another immediately, without downloading a new resource from a remote server, unless the switched-to screen's state is such that it is to display a resource that is not contained in the app package or in a cache of previously-downloaded resources.

A key feature of an ABML app and an ABML browser is the support for the URI dispatch table, which ties everything together and almost completely automates the transition of states. There is almost no need for a traditional imperative programming language (e.g., JavaScript), which yields benefits described below. Instead, the declarative language (ABML) and expression language (e.g., XPath, described above) makes an ABML package very compact in comparison to traditional HTML documents and JavaScript programs that achieve similar end-user functionality.

In the embodiment presently under consideration, instead of the general, possibly-repeated translation of an input URI to an output URI, this embodiment performs only a single translation according to the “show” attribute of the first URI translation table entry whose “pattern” attribute matches the input URI. And second, the result of the translation is not treated as a generic URI, but as a UI-object path (i.e., the “show” attribute names a UI-object and possibly a message to be sent; the name and/or message may be constant or may incorporate variable values).

Thus, for example, in lines 80-90 of Listing 1, reproduced here as Listing 2:

80<abml:entry pattern=‘products/{$filter}’
90show=‘tabs/products’/>

### Listing 2:

if an event such as a screen tap, button press or timer expiration causes the ABML browser to process a URI of the form “products/12345”, then the result of processing the URI through the dispatch table is to send a message (e.g. , a “refresh/update” message) to the UI object named “tabs/products”. This might cause a screen to present a listing of products to appear on the device display. (In this example, the variable {$filier}, whose value would be “12345”, does not form part of the UI-object path.)

Other variations of URI dispatch table processing include the definition of variables by particular entries, so that the variables' values are available for use by UI objects, see line 30 of Listing 3:

| | |
|---|---|
| 10 | <abml:dispatch-table> |
| 20 | <abml:entry pattern=‘products/stationary/{$product_id} |
| | show=‘stat_win’> |
| 30 | <abml:variable name=‘domain’ |
| | value=‘http://dataserver.example.com/’> |
| 40 | </abml:entry> |
| 50 | </abml:dispatch-table> |

### Listing 3

In this example, although the value of the {$domain} variable is not matched or obtained from the input URI (as the {$product_id} variable is), its value would nonetheless be set to the string “http://dataserver.example.com/”.

In another alternate variation, instead of using the “show” attribute of the dispatch table to identify which one of the windows in the ABML app should be shown, a separate stanza of the ABML package could use a variable (set by the URI dispatch processing) to select the window to show:

| | |
|---|---|
| 10 | <abml:dispatch> |
| 20 | <abml:entry pattern=‘ ’> |
| 30 | <abml:variable name=‘window_name’ value=‘intro’/> |
| 40 | </abml:entry> |
| 50 | <abml:entry pattern=‘{$window_name}/{$tab_name}’/> |
| 60 | <abml: ui-object-not-found show=‘error-window’/> |
| 70 | </abml:dispatch> |
| 80 | <abml:root-window select-item=‘{$window_name}’> |
| 90 | <abml:window name=‘intro’/> |
| 100 | <abml:tab-container-window select-item=‘{$tab_name}’> |
| 110 | <abml:tab name=‘Tri’ title=‘Triangle’/> |
| 120 | <abml:tab name=‘Sqr’ title=‘Square’/> |
| 130 | </abml:tab-container-window> |
| 140 | <!-- [...etc...] --> |
| 150 | </abml:root-window> |

### Listing 4

In this example, a blank input URI would match the entry pattern at line 20 and cause variable {$window name} to be set to “intro” according to line 30. Then, in the root-window stanza at line 80 would cause the window named by the {$window_name} variable to be displayed. The upshot of this example is that processing a blank input URI would result in the display of the “intro” window—all without any extra requests issued to a remote web server.

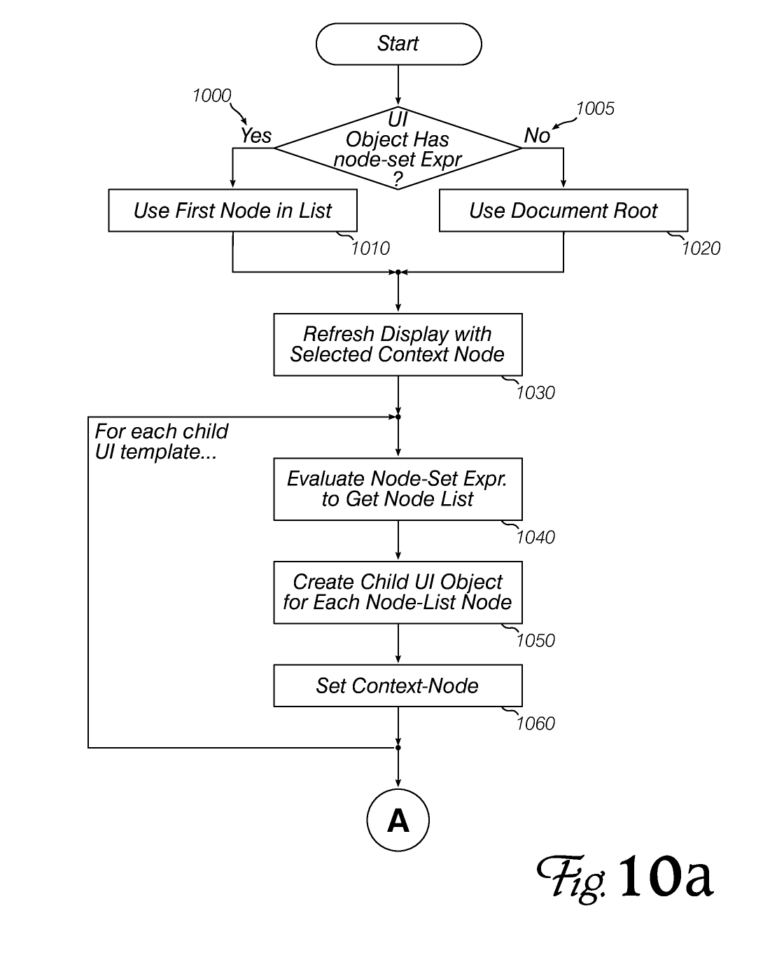

FIG. 9 outlines another algorithm for processing after URI dispatch table activity. Again, the method begins with the processed result 740, but recall that in this embodiment, a maximum of one match was performed. The result is examined to see whether it identifies a valid UI-object path. If not (900), appropriate error handling is initiated (905). If, on the other hand, the path is valid (910), then the top-level ancestor whose hierarchy includes the named UI object is located (915). This ancestor is marked to be made visible (920). In addition, if the object has children (925), then some or all of these are marked to be made visible. Specifically, the object type and characteristics are examined to see whether all of its children should be visible (930). If so (935), then all of the children are marked also (940). If only some (or one or none) of the children are to be made visible (945), then only the appropriate child (or children) is (are) marked (950). This process is performed recursively, rather than iteratively as looping arrow 955 suggests, but at the end of this processing, all UI objects that should be visible have been so marked. When there are no more children to process (960), the display is refreshed (965), resulting in the new state's screen being displayed.

An example of a UI object which has children that may not all be visible is the tabbed window. Each tab may be represented by a child UI object, and each of those children may have its own sub-children to display or manipulate information associated with the tab. When processing the tabbed window, only the currently-selected tab (and its children) are marked visible, so only those children are displayed when the screen is eventually refreshed.

It is appreciated that the URI dispatch table processing discussed above is a subset of general text processing, i.e., that only some portions of the data in an ABML package that match the URI syntax are selected for translation and subsequent processing. An embodiment may provide greater power and flexibility by performing matching and substitution on more (or even all) of the data in the ABML package. This can be accomplished efficiently in an ABML browser by constructing lexical and syntactic analyzers to identify (match) portions of interest in the ABML package and perform translations or substitutions on them.

Another feature of ABML that has been proven useful in some embodiments is to provide all UI objects with a property (called “context-node” in this description) which can be associated with internal, external or embedded content for use in content-displaying and event-handling operations. In an exemplary embodiment, an event handler can be declared in a UI object, and will be invoked in response to a user's actions or an automatic timeout. When an event handler is invoked, the context-node of the UI object is available to it. The event handler can use content from that context-node, or can override it with content from some other context-node. Since context-nodes can be loaded from remote data sources, an ABML app can make use of this feature to create dynamic applications that respond differently according to remote data.

Continuing in the description of this embodiment, an XPath expression is always evaluated in relation to a context-node, so depending on the position of the context-node in the external content document, the result of the XPath expression can be different. Thus, an ABML app can make use of this characteristic of XPath evaluation to generate display content and event function parameters according to data in external content files. By combining external content data, the URI dispatch table functionality and event handling, an interactive application can be built without the use of imperative programming.

Please note that this method can also be used with other structured-data sources (ones that deliver data in a non-XML format). For example, the JavaScript Object Notation, “JSON,” is a popular format that can be processed mechanically through the URI dispatch table to accomplish similar application goals.

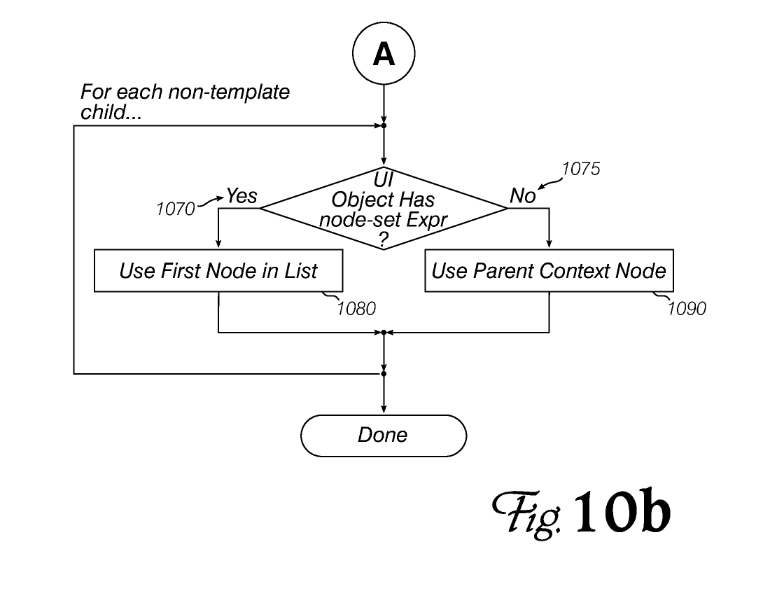

The following ABML example code fragments and context-node processing as outlined in relation to FIG. 10 will help illustrate the power offered by this feature of an embodiment. Listing 5 shows how a UI component called “article-view” (a window-derived object suitable for displaying mainly textual data such as a magazine article or, in this example, information about a product in a catalog) can be configured to obtain its content from different sources:

| | |
|---|---|
| 10 | <abml:dispatch> |
| 20 | <abml:entry pattern=‘product/{$product_id}’ |
| 30 | show=‘product_window’/> |
| 40 | <abml:entry pattern=‘supplier/{$supplier_id}’ |
| 50 | show=‘supplier_window’/> |
| 60 | <abml:entry pattern=‘inventory/{$product_id}’ |
| 70 | show=‘inventory_window’/> |
| 80 | </abml:dispatch> |
| 90 | <abml:window name=‘product_window’> |
| 100 | <abml:article-view |
| 110 | data-src=‘http://store.example.com/product/{$product_id}’ |
| 120 | select=‘ar:article’> |
| 130 | <abml:case event=‘single-tapped’ |
| 140 | match=‘ar:image[@class=“supplier_pic”]′> |
| 150 | <abml:go href=‘supplier/{@su:supplier_id}’/> |
| 160 | </abml:case> |
| 170 | <abml:case event=‘single-tapped’> |
| 180 | <abml:go href=‘inventory/{$product_id}’/> |
| 190 | </abml:case> |
| 200 | </abml:article-view> |
| 210 | <abml:window name=‘supplier_window’> |
| 220 | . |
| 230 | . |
| 240 | </abml:window> |
| 250 | <abml:window name=‘inventory_window’> |
| 260 | . |
| 270 | . |
| 280 | </abml:window> |

### Listing 5

Here, the “data-src” assignment at line 110 provides information to retrieve a complete block of related data from a remote source (for example, data about a product, including its name, description, photo, price, shipping weight, and so on). Then, the “select” line at 120 permits a subset of the retrieved block to be processed (displayed, etc). In Listing 5, “select=ar:article” might select a portion of the block containing a general description of the product for display.

The “data-src” attribute at line 110 and the “select” attribute at line 120 are both used to provide a content node for the article-view object at line 100. When a “single-tapped” event occurs and the selected or tapped object (an XML node) matches the pattern given at line 140, then the ABML browser will receive an relative input URI ‘supplier/{@su:supplier_id}’, the relative URI will be processed by the URI dispatch table and in this case, the ‘supplier_window window will be shown as indicated by the dispatch table entry in line 40. On the other hand, if the tapped object does not match the pattern at line 140, then the ‘inventory_window’ will be shown as indicated by the dispatch table entry in line 60.” Note that processing the various URIs and URI-like strings through the URI dispatch table, as occurs in a single-tap event (among other events), gives embodiments an opportunity to construct a comprehensive browsing history, which remedies a common problem of the AJAX-based prior art, that the “Back” functionality of an ordinary web browser is often impaired when paging through a sequence of content resources that are all associated with a common URL.

The “select” attribute of line 30 only uses one node, but ABML generally allows the app developer to work with a list of nodes, for example to create a UI object for each node in a list. A simple example of this is shown in Listing 6:

| | |
|---|---|
| 10 | <abml:list-view grouped=‘true’ |
| 20 | data-src=‘http://store.example.com/products/{$filter}’> |
| 30 | <abml:list-section-template |
| 40 | select=‘/pc:catalog/pc:category’ |
| 50 | header-title=‘{@name}’> |
| 60 | <abml:custom-list-item-template |
| 70 | select=‘pc:product’> |
| 80 | <abml:article-view |
| 90 | select=‘ar:article’/> |
| 100 | <abml:case event=‘item-selected’> |
| 110 | <abml:go href=‘product/{@product_id}’/> |
| 120 | </abml:case> |
| 130 | </abml:custom-list-item-template> |
| 140 | </abml:list-section-template> |
| 150 | </abml:list-view> |

### Listing 6

After the content specified by “data-src” line 20 is retrieved, the “list-section-template” stanza from line 30 through 140 is used to create new UI objects. In this example, a “list-section” object will be created for each node in the node list produced from the “select” expression of line 40, “/pc:catalog/pc:category”. Each new object's context-node will be set to the corresponding node in the node list.

The same process will be applied to the “custom-list-item-template” at line 60, where a “custom-list-item” will be created for each “pc:product” element in the node list. Each custom-list item will have a new child “article-view”, thanks to lines 80-90.

FIG. 10 outlines the process from the vantage point of the ABML browser. This method operates recursively on a hierarchical tree constructed when a UI object has downloaded and parsed a content document. If the UI object has a node-set expression to select a context node relative to the root of the parsed document (1000), then the object's context node is the first node of the node list (1010). Otherwise (1005), the object's context node is simply the root node of the content document (1020).

Next, the UI object refreshes its display content with the updated context node (1030). Then, for each child UI object template of the UI object, the node-set expression of the template is evaluated to create a node list (1040). A child UI object is created using the template for each node in the node list (1050), and the child object's context-node is set to the corresponding node in the node list (1060).

Finally, for child UI objects that are not templates, if the object has a node-set expression (1070), then its context-node is the first node of the node list (1080). If it has no node-set expression (1075), then the object's context node is the same as the parent's (1090).

As noted previously, an ABML document is a data stream or file composed in a markup language such as Extensible Markup Language (“XML”). In particular, valid ABML documents can be represented in a printable or text-based form that can be processed by existing tools. Therefore, information present in an ABML app can be indexed by search engines and similar web-crawlers, so the apps can be located easily by users.

ABML (like XML) defines a comprehensive syntax for representing hierarchical data structures in a linear byte stream. Thus, an ABML document can be stored, delivered, and manipulated as a traditional data file, by any tools, programs or machines used for that purpose. It is appreciated that, just as traditional resources such as graphic images and text translations can be included within an ABML package's hierarchical structure (or in an abstract directory structure of an archive file), so too can a complete ABML package(which may in turn include its own supporting resources). Thus, a composite ABML app (for example, a personal information management app) may include a phone directory, an address book and an electronic-mail application as distinct sub-units that can be accessed and manipulated. The URI dispatch table of the “main” app may direct a program implementing an ABML browser embodiment of the invention to activate one of these sub-applications in response to an event indicating the user's selection of a graphical image (“icon”) associated with the sub-application. Starting and executing the sub-application corresponds to beginning to operate and dispatch events according to the URI dispatch table of the sub-application.

Markup languages that can represent arbitrary hierarchies as linear data streams often contain a great deal of redundant information. Consequently, data compression techniques are frequently effective at reducing the size of the data stream. Smaller streams may no longer be indexable and searchable by web crawlers, but they can be transmitted from server to client more quickly. (It is appreciated that a web crawler could also be extended according to an embodiment of the invention to decompress an ABML package so that its constituent data and resources can be indexed.) In some embodiments, ABML packages may be stored and/or transmitted in compressed form to improve download performance. Alternatively, some portions of an ABML package may be maintained in compressed form, while others are left uncompressed. This arrangement maintains some of the benefits of searchability and some of the improved transmission performance, at a cost of somewhat increased software complexity.

An embodiment need not offer a full programming (scripting) language among the functions accessible to a markup-language document. By implementing only connections among internal resources and between internal and external resources via the URI dispatch table, any desired functionality can be provided to a user. (If a function is too complex to be implemented via URI dispatch, an external URL can be used to cause the function to be performed remotely.) The absence of a scripting capability can improve the security of an embodiment, and also allow the embodiment to meet certain commercial restrictions. For example, the Apple Corporation of Cupertino, Calif., refuses to allow software that offers arbitrary programming capabilities to be installed on many of its products. A program implementing the scriptless embodiment described above can bring powerful, flexible mobile application development capabilities to users and developers of software for Apple's devices.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

One particularly useful embodiment is distributed in a form commonly called a “library.” In this embodiment, instructions to perform the functions described above are provided without logic to activate the functions in any particular order. Instead, this logic is provided by a program written by an application developer. However, instead of writing both the application logic and the functions of an embodiment of the invention, the developer simply inserts “subroutine calls” into his own code, to invoke the functions stored in the library embodiment. By joining the developer's program and the library through a procedure called “linking,” a complete application can be constructed.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that efficient, flexible mobile application frameworks can also be produced by software and hardware that distribute the functions of embodiments of this invention differently than herein described. Such variations and implementations are understood to be captured according to the following claims.

I claim:

1. A mobile application framework comprising:
a browser to retrieve a document from a resource server, the document formatted in a hierarchical markup language and containing a URI dispatch table; and
a document formatted in a hierarchical markup language and containing a URI dispatch table, wherein
the browser comprises instructions to receive a first URI, convert the first URI into a second URI according to entries in the URI dispatch table, and perform an action according to the second URI.

2. The mobile application framework of claim 1 wherein the hierarchical markup language is the Extensible Markup Language (“XML”).

3. The mobile application framework of claim 1 wherein the second URI identifies an element within the document.

4. The mobile application framework of claim 3 wherein the element is one of an image, a user-interface component, or a sub-document formatted in the hierarchical markup language.

5. A method comprising:
downloading a package from a remote server via a distributed data connection;
extracting a document from the package, the document formatted in a markup language and containing a URI dispatch table;
processing a first URI-like string by matching elements of the first URI-like string to patterns in the URI dispatch table;
constructing a second URI-like string by combining elements from the URI dispatch table and variables matched in the processing operation;
using the second URI-like string to select a resource from the package; and
displaying the resource.

6. The method of claim 5 wherein the resource is an image.

7. The method of claim 5 wherein the resource is a user-interface component.

8. The method of claim 7, further comprising:
constructing a third URI-like string by combining elements from an attribute value of the user-interface component and variables matched during the processing operation; and
using the third URI-like string to affect a remote resource.

9. The method of claim 5 wherein the resource is a sub-package stored within the package, said sub-package containing a second URI dispatch table.

10. The method of claim 9, further comprising:
processing a third URI-like string by matching elements of the third URI-like string to patterns in the second URI dispatch table;
constructing a fourth URI-like string by combining elements from the second URI dispatch table and variables matched during a URI processing operation;
using the fourth URI-like string to affect a resource from the sub-package.

11. The method of claim 10 wherein the resource from the sub-package is a user-interface control.

12. The method of claim 5 wherein the second URI comprises at least three path segments separated by at least two different delimiter characters.

13. A computer-readable medium containing instructions to cause a programmable processor to perform operations comprising:
parsing a first URL into a plurality of delimiter-separated segments;
assigning at least one of the delimiter-separated segments as a value of a variable;
constructing a second URL containing a plurality of delimiter-separated segments, at least one of the segments containing the value of the variable; and
sending a message to a user-interface component comprising a plurality of child components, wherein a name of the user-interface-component matches the second URL, and wherein sending the message causes the user-interface component to display a subset of the plurality of child components.

14. The computer-readable medium of claim 13, containing additional instructions to cause the programmable processor to perform operations comprising:
constructing a third URL containing a plurality of delimiter-separated segments, at least one of the segments containing the value of the variable;
transmitting the third URL to a remote server to obtain a resource identified by the third URL;
receiving a JavaScript Object Notation (“JSON”) data sequence from the remote server; and
providing information from the JSON data sequence to the user interface component to affect a display of the user interface component or a child component of the user interface component.

15. The computer-readable medium of claim 13 containing additional instructions to cause the programmable processor to perform operations comprising:
determining a context-node of the user-interface component by selecting a node relative to the context-node of a parent component of the user-interface component or an overriding context-node of the user-interface component.

16. The computer-readable medium of claim 13 containing additional instructions to cause the programmable processor to perform operations comprising:
evaluating an XPath expression in relation to a context-node of a first UI component to produce a first evaluated XPath expression; and
evaluating the XPath expression in relation to a context-node of a second UI component to produce a second evaluated XPath expression, wherein the first evaluated XPath expression is different from the second evaluated XPath expression.

17. The computer-readable medium of claim 13 wherein the delimiter-separated segments of the first URL are separated by at least two different delimiter characters.

18. The computer-readable medium of claim 13 wherein the delimiter-separated segments of the second URL are separated by at least two different delimiter characters.

19. The computer-readable medium of claim 13 wherein the instructions comprise a binary library for linking to a separate sequence of instructions, said second sequence of instructions implementing logic for invoking the parsing, assigning, constructing and sending operations.

20. The computer-readable medium of claim 13 wherein the second URL comprises a leading portion containing a plurality of delimiter-separated segments joined by a plurality of first delimiter characters, followed by a second, different delimiter character and one segment, said one segment forming the message sent to the user-interface component.
